(19) United States
(12) Patent Application Publication
(10) Pub. No.: US 2011/0012366 A1
(43) Pub. Date: Jan. 20, 2011

(54) Stirling Machine

(76) Inventors: Jarlath Michael McEntee, Castine, ME (US); Stephen Charles Welty, Cambridgeshire (GB); Jonathan James Childs, Peterborough (GB)

Correspondence Address: Ballard Spahr LLP, SUITE 1000, 999 PEACHTREE STREET, ATLANTA, GA, 30309-3915, US

(21) Appl. No.: 12/086,894

(22) PCT Filed: Dec. 21, 2006
(86) PCT No.: PCT/GB2006/004886

§ 371 Date: Oct. 6, 2010

(30) Foreign Application Priority Data
Dec. 23, 2005 (GB) 0526436.1
Mar. 31, 2006 (GB) 0606573.4

(51) Int. Cl. H02K 7/18; F02G 1/04

(52) U.S. Cl. 290/1 A; 60/517

(57) ABSTRACT

A Stirling machine comprising a reciprocating power piston with a power magnet, and a stator having a coil electromagnetically coupled to the power magnet. At least one spring magnet is arranged to provide an axial centring force on the piston. The spring magnet is fixed with respect to the stator.

The present invention relates to a Stirling machine and, in particular, to an improved design of alternator for a Stirling machine.

In a Stirling machine, a power piston reciprocates within a stator either to drive the power piston or to generate electricity. The power piston is provided with at least one power magnet which reciprocates with respect to a stator.

In order to maintain the piston in a central position with respect to the stator, secondary or spring magnets are provided on the piston. These are positioned on both sides of the power magnet and have a polarity opposite to that of the main magnet. When the piston is displaced, the spring magnets exert a force in the direction opposing the direction of displacement thereby biasing the piston towards its central position. Also, if the stroke of the piston should exceed a pre-determined limit, the spring magnets generate an increased restoring force with increasing displacement thereby helping to ensure that each stroke of the power piston stays within the pre-determined limit.

Stirling machines having constructions of this type are known in U.S. Pat. No. 4,827,163 and U.S. Pat. No. 5,148,066.

According to the present invention, a Stirling machine comprises a reciprocating power piston with a power magnet, a stator having a coil electromagnetically coupled to the power magnet; and at least one spring magnet arranged to provide a centring force on the piston, the spring magnet being fixed with respect to the stator.

By fixing the spring magnet with respect to the stator, a number of advantages arise.

In the prior art, as the piston reciprocates, the spring magnets co-operate with the laminations within the stator to generate the restoring force. However, with the present invention, the spring magnet co-operates with the power magnet which generates an increased restoring force, for a given size of spring magnet.

Also, the spring magnets on the static stator can be positioned further away from the centre of reciprocation of the piston. This is more difficult to achieve for spring magnets mounted on the power piston as it may serve to increase the length of the reciprocating element and of the machine as a whole. Positioning the spring magnets in such a way, will interfere less with the power magnet when it is within its normal range of movement thereby, again, improving the efficiency of the machine.

In the broadest sense, the present invention could be implemented with a single spring magnet at one end of the stator as this would provide the benefits set out above at least for one end of the piston stroke. However, it is preferable to have a spring magnet at each end of the stator so that the advantages are provided at both ends of the piston stroke.

The present invention could be implemented with the power magnet being mounted directly on the power piston. However, preferably, the power piston includes a hollow drum on which the power magnet is mounted, and the stator comprises an annular gap in which the drum and power magnet reciprocate. In this case, the stator comprises inner and outer stator elements. The or each spring magnet may be positioned either on the inner or the outer stator element.

When the spring magnets are provided at opposite ends of the stator, the spacing between the spring magnets is preferably greater than the overall axial length of the power magnet. Typically, the axial spacing between the spring magnets is at least 10% greater than the overall axial length of the power magnet and more preferably at least 20% greater. By spacing the magnets in this way, they are substantially outside the main flux circuit and therefore do not disrupt the flux pattern during operation.

Preferably, the or each spring magnet is comprised of two or more spring magnet sections spaced in the direction of reciprocation and separated by a non-magnetic gap. The section closest to the centre of reciprocation generates a first peak force on the reciprocating power piston which acts to centre the power piston in the manner previously described. The section furthest from the centre of reciprocation generates a second peak force, preferably larger than the first peak force, which will act on the reciprocating piston during a period of extreme operation where excessive amplitudes occur. This acts to catch the piston before overstroke occurs and effectively provides a back-up to the first peak force.

Preferably, the or each spring magnet is radially spaced from the power piston. This effectively allows the power piston to reciprocate past the spring magnet while retaining a substantially constant gap between the power piston and spring magnet. However, alternatively or additionally, the or each spring magnet is axially spaced from the power piston such that the power piston reciprocates towards and away from the spring magnet when in use.

In this case, the spring magnet should be magnetised to the same polarity as an adjacent magnet on the power piston to generate a repelling force which increases as the power piston approaches the spring magnet. In this case, preferably, the axially spaced spring magnet is provided with a resilient cushion between the spring magnet and the power piston. The cushion reduces damage and noise should the power piston travel beyond a pre-determined limit.

All of the magnets which contribute to the centring force may be provided on the stator, such that only the power magnet is provided on the power piston. This has the advantage that the power piston and the stator may each be provided with magnets of a single polarity. This allows both components to be assembled and subsequently magnetised. This contrasts with the prior art in which magnets of opposite plurality are provided on a single component and cannot therefore be magnetised in situ. Instead, pre-magnetised spring magnets must be attached to the piston which is already provided with the magnetised power magnet.

Alternatively, however, the or each spring magnet is associated with a respective auxiliary magnet positioned on the power piston and is arranged to co-operate with its associated spring magnet to generate a centring force on the piston. The auxiliary magnets may be of opposite polarity to the power magnets in which case the above advantage of ease of assembly does not arise. However, the auxiliary magnets have been found to provide even higher restoring forces on the power piston towards its extremities of travel and to provide lower mid-range retarding forces, thereby having less adverse effect on the power piston during its normal reciprocation.

Examples of machines constructed in accordance with the present invention will now be described, with reference to the accompanying drawings, in which:

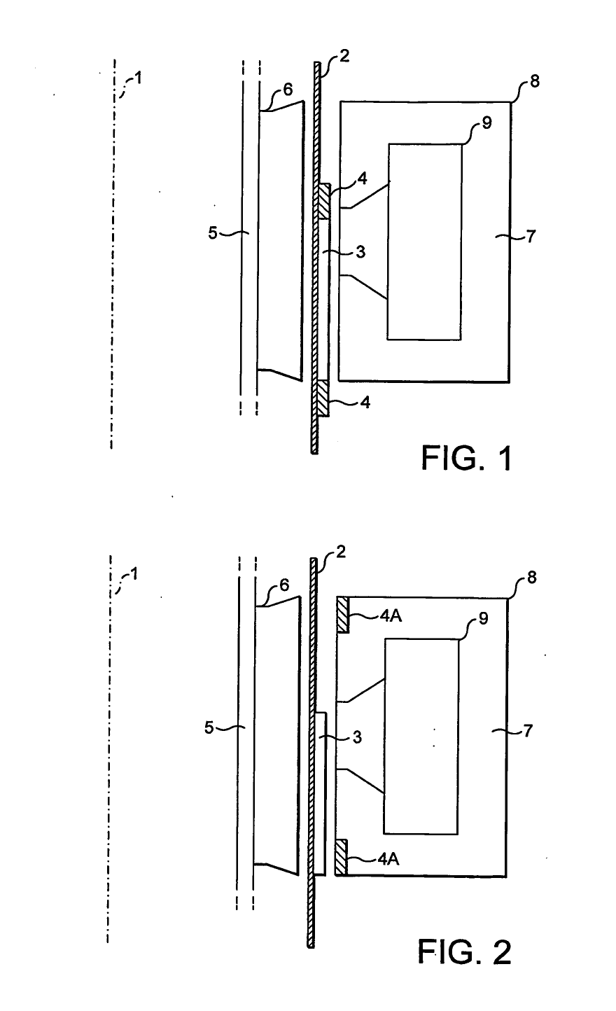

FIG. 1 is a cross-section through a right-hand portion of an alternator assembly in accordance with the prior art;

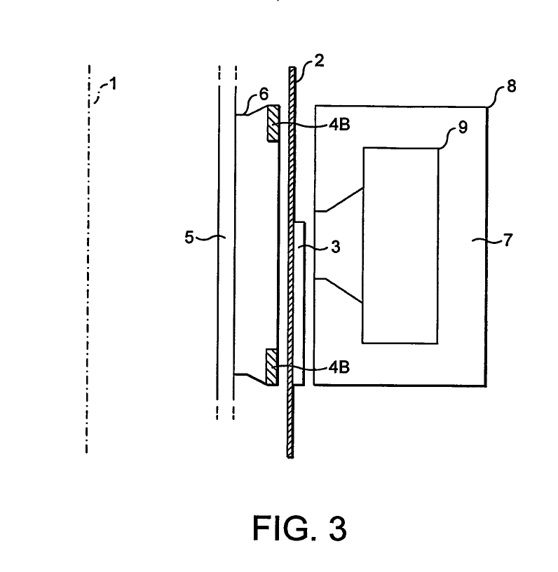

FIG. 2 is a similar view of a first example of the present invention;

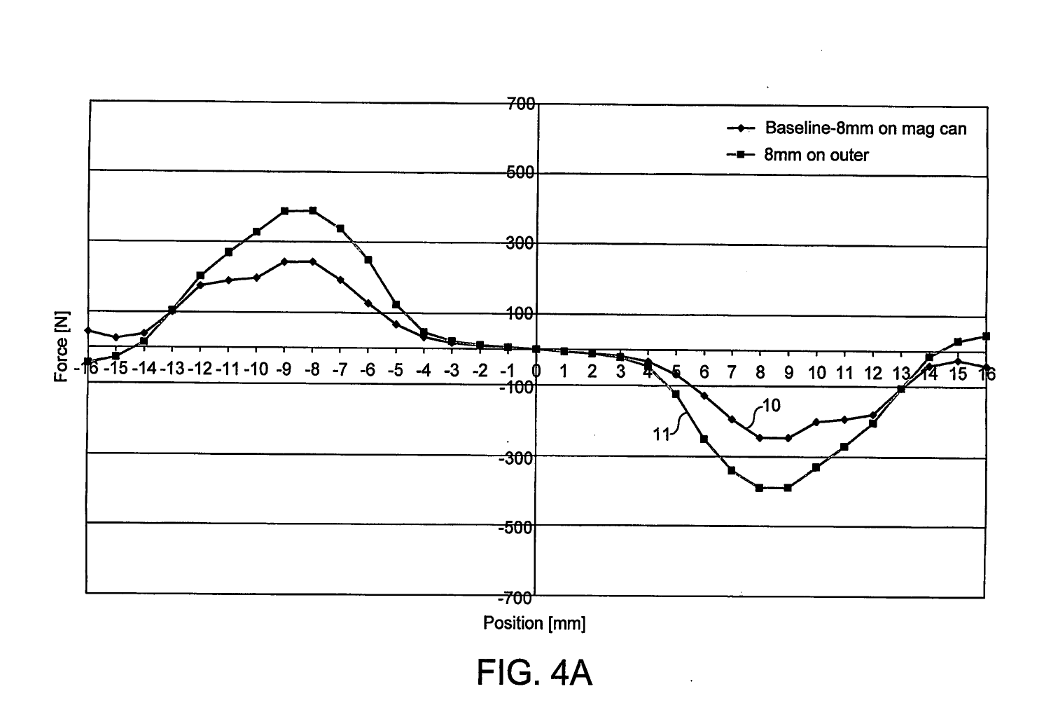

FIG. 3 is a similar view of a second example;

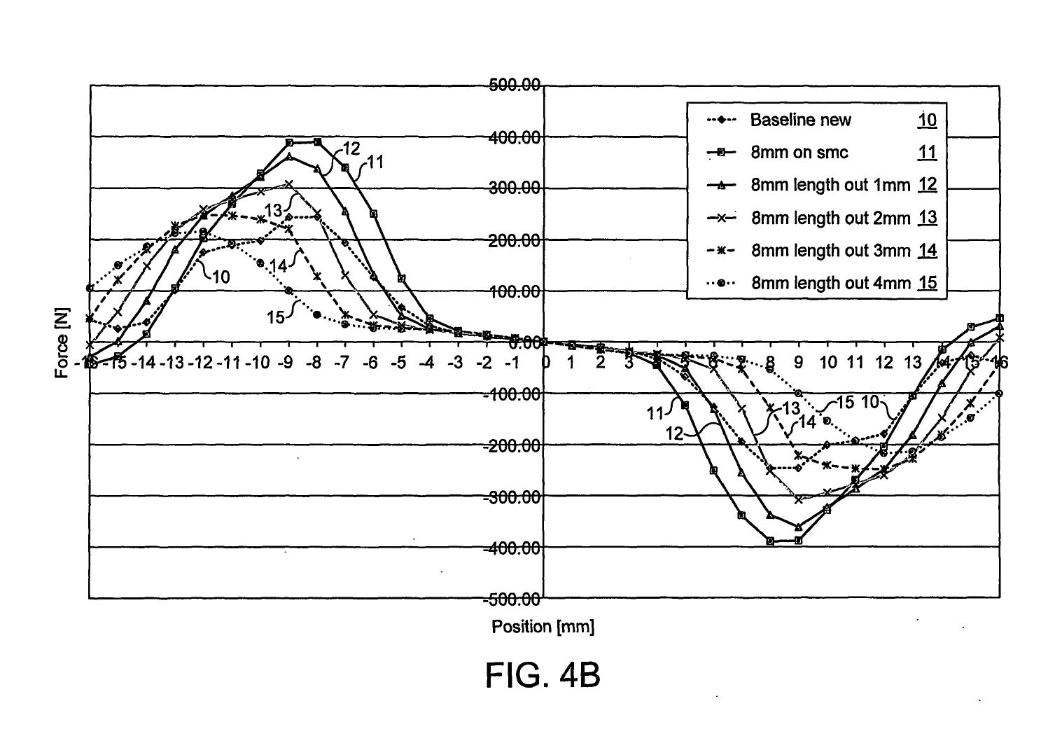

FIGS. 4A and 4B are graphs illustrating the advantage provided by the present invention;

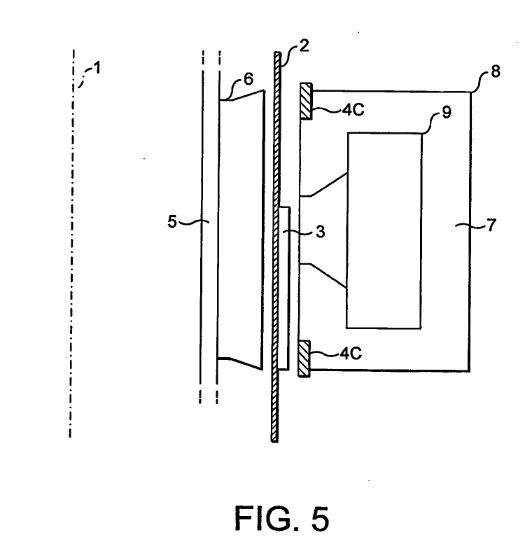

FIG. 5 is a view similar to FIGS. 1 to 3 showing a third example of the invention;

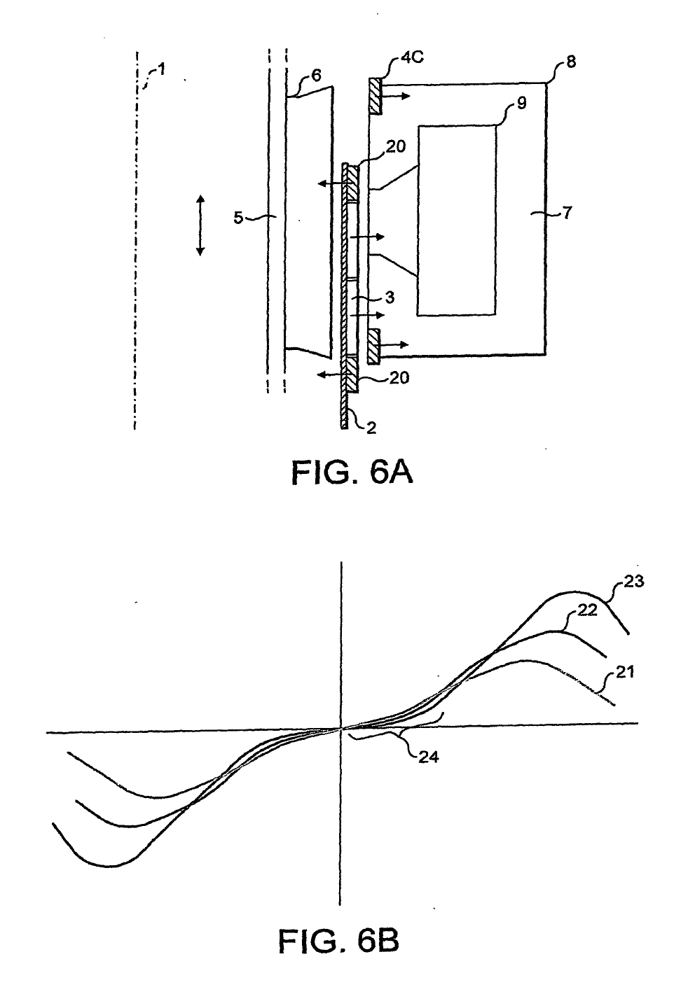

FIG. 6A is a view similar to FIGS. 1 to 3 and 5 showing a fourth example of the invention;

FIG. 6B is a graph similar to that shown in FIGS. 4A and 4B showing the enhancement provided by the example of FIG. 6A;

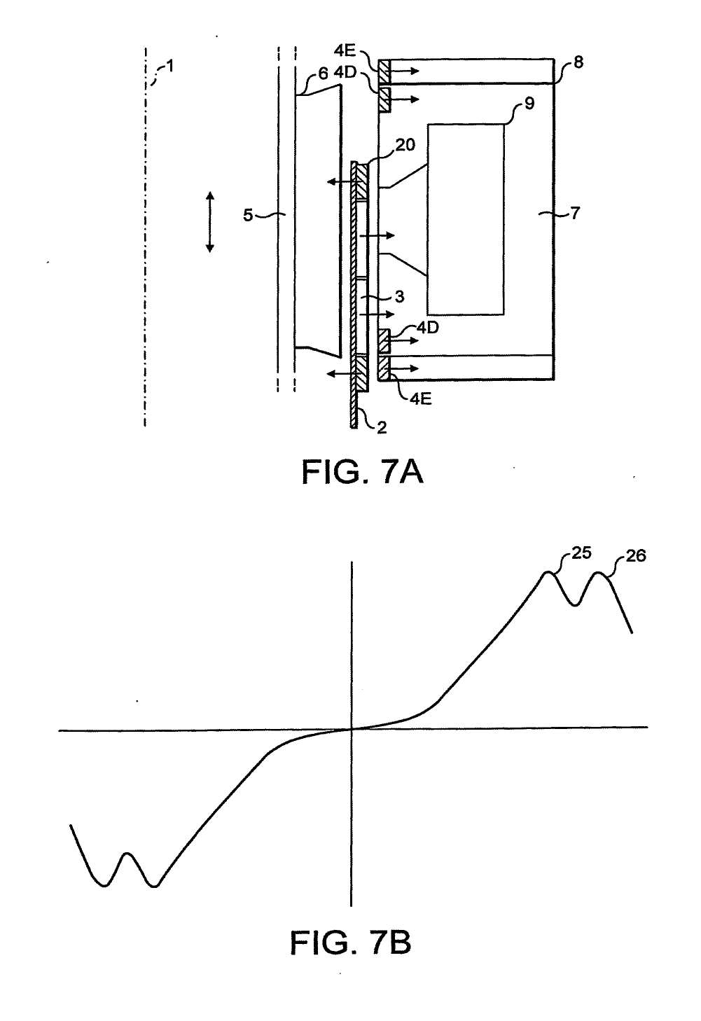

FIG. 7A is a view similar to FIGS. 1 to 3, 5 and 6A showing a fifth example;

FIG. 7B is a graph similar to FIGS. 4A, 4B and 6B showing the response characteristics of the example of FIG. 7A; and

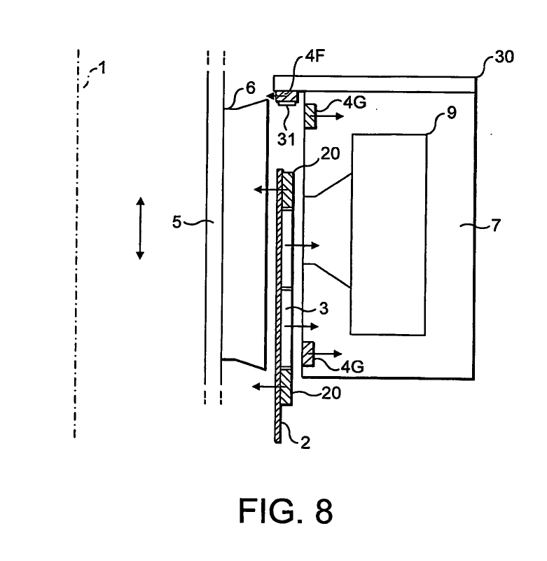

FIG. 8 is a view similar to FIGS. 1 to 3, 5, 6A and 7A showing a sixth example of the invention.

The present invention relates to electromechanical Stirling machines which are well-known in the art and will not be described further here. The present invention has been specifically designed for a linear free piston Stirling engine which is intended for use with a domestic combined heat and power (DCHP) system. However, the principle is applicable to any such electromechanical Stirling machine. As is well-known, the Stirling engine comprises a power piston which reciprocates with respect to a stator either to drive the power piston or to generate electricity.

FIG. 1 represents a machine known in the prior art, for example, in U.S. Pat. No. 4,827,163 and U.S. Pat. No. 5,148,066. The machine has a main axis 1 which provides the central axis of reciprocation. In FIG. 1 and subsequent figures, only the right-hand part of the alternator is shown. The components are illustrated in cross-section and have an annular configuration centred on the axis 1. Thus, the left-hand side of the alternator is a mirror image of the right-hand side positioned a corresponding distance to the left of the axis 1.

The power piston (not shown) is attached to an annular drum 2 which is arranged to reciprocate axially together with the power piston. An annular power magnet 3 is attached to the drum. Annular spring magnets 4 of opposite polarity to the power magnet 3 are positioned at either end of the power magnet 3.

The drum 2 and magnets 3, 4 reciprocate with respect to the remainder of the components illustrated in FIG. 1 which remain static.

The static components comprise an annular cylinder 5, to which is located inside an annular inner stator element 6. The components are positioned radially inwardly of the drum 2. Radially outwardly of the drum is the outer stator element 7 which comprises a plurality of laminations 8 and a coil 9 as is well-known in the art.

As the power piston and the drum 2 reciprocate, the power magnet 3 is electromagnetically coupled to the coil 9 either to generate electricity within the coil 9 or to move the power piston. When in an at rest position, the spring magnets 4 generate a force acting towards a central position on the power piston. This is sufficient to overcome any gravitational effect acting on the power piston which would otherwise cause it to move downward, thereby maintaining the power piston in the central position. In the central position (the drum 2 is higher than illustrated in FIG. 1) the spring magnets 4 are equally spaced from the respective ends of the stator.

As the drum 2 moves beyond a pre-determined position, the force generated by the spring magnets which opposes the reciprocating force becomes increasingly large, thereby preventing the drum from moving outside its desirable operating limit.

A first example of the present invention is shown in FIG. 2. Most of the components are the same as those shown in FIG. 1 and have been designated the same reference numerals. The only difference is that the spring magnets 4A are now on the outer stator element 7 rather than the drum 1. The spring magnets 4A may be either ring magnets, or a plurality of circumferentially arranged sections.

A second example is shown in FIG. 3. Again, this has most of the same components as the previous examples.

In this case, the spring magnets 4B are positioned on the inner stator element 6.

In both cases, it can be seen that the spacing between the spring magnets 4A, 4B is greater than the spacing between the spring magnets 4. In order to manufacture either of the arrangements in FIGS. 2 and 3, the spring magnets are mounted to the appropriate stator elements 6,7 before being magnetised in situ, but they can be magnetised prior to assembly.

The effects of transferring the spring magnet from the drum to the stator are illustrated in FIGS. 4A and 4B.

FIG. 4A shows the force generated by the spring magnet at a given position from the centre of reciprocation. Line 10 represents the force generated by the prior art arrangement of FIG. 1 while line 11 represents the force generated by the present invention. In each case, the force peaks at around the same point. The peak force occurs at each end of the cycle, with opposing directions at upper and lower limits as it always acts towards the centre of reciprocation. It can be seen that by moving the spring magnets from the drum 2 to the stator, the centring force is increased significantly. The force in the central area is still maintained at approximately 30N towards the centre. This is sufficient to keep the power piston in the centre when not reciprocating, overcoming the effects of gravity on the vertically mounted piston.

It is also advantageous to maintain higher centring forces after the drum passes the peak. During extreme operation, it is possible that higher amplitudes of reciprocation would result in the lower centring forces that occur on the outer trailing edges of the peak. In such a case, the lower forces in this area may not be sufficient to pull the piston back to the centre and overstroke may occur. It is even possible under some extreme conditions that the forces generated by the spring magnets may push the piston further outwards instead of pulling it back in. It is therefore advantageous to position the spring magnets in order to provide a necessary minimum force during the inner part of the cycle without losing the critical centring effects that are produced at the extremities of operation. The peak should then be as flat as possible to ensure that lower centring forces on the trailing edge are not encountered.

According to the example shown in FIG. 5, the spring magnets 4C have been moved axially further apart. The example is otherwise identical to the example of FIG. 2.

The effects of this are shown in FIG. 4B. This shows the same two lines 10, 11 shown in FIG. 4A. In addition, a graph shows the number of additional lines 12-15 each progressively increasing the spacing of the spring magnets progressively by 1 mm. As can be seen, by moving the magnets axially outwards from the centre, the peak force will occur further away from the centre of reciprocation allowing a greater amplitude of reciprocation to be achieved. This will increase the power generated. In addition to moving the peak centring force outwards, moving the spring magnets has the-effect of flattening the curve as is apparent from line 15 in FIG. 4B. For the current design, the ideal position with the peak centring force to occur is at a reciprocating amplitude of 12-13 mm. This, can be achieved by positioning the spring magnets approximately 4 mm further away from the main magnet. This provides the best compromise in that a lower centring force (approximately 30N) is present in the middle part of the cycle, the centring forces occur at 12-13 mm from the centre, and an extended peak is achieved such that higher centring forces are provided well beyond the ideal piston limits.

A fourth example of the invention is shown in FIGS. 6A and 6B. This example has all of the features of the third example of FIG. 5. It will be understood, however, that it could also be applicable to the first and second examples of FIGS. 1 and 2. The enhancement provided in the fourth example is the presence of auxiliary magnets 20 on the drum 2. These are positioned at opposite axial ends of the power magnet 3 (in this case shown as two separate sections). The auxiliary magnets 20 have opposite polarity to the power magnets 3 and also opposite polarity to the spring magnets 4C. The presence of the auxiliary magnets 20 provides a further enhancement to the force-amplitude curve as shown in FIG. 6B. In this, line 21 represents the restoring force provided by the prior art with the magnets mounted only on the drum 2, line 22 represents the restoring force of the third example with the magnets mounted only on the stator, and line 23 represents the force for FIG. 6A. It can be seen that the peak force is significantly enhanced (up to approximately 600 Newtons as compared to 400 Newtons for the third example and 200 Newtons for the prior art). It is apparent that the restoring force in the lower amplitude region (represented by region 24 in FIG. 6B) is less than the prior art and third example, thereby improving the efficiency of the operation of the machine in its normal range of operation.

A fifth example of the present invention is shown in FIGS. 7A and 7B. This is illustrated as having all of the features of the fourth example of FIG. 6A, but it will be appreciated that the concept is equally applicable to the earlier examples. In other words, it does not necessarily require the presence of the auxiliary magnet 20, and it could also be applicable to the spring magnets being mounted on the inner stator element 6 rather than the outer stator element 7.

In this example, each spring magnet is made up of two spring elements 4D, 4E, separated by a non-magnetic gap. The spring magnet element 4D is the inner element in the sense that it is closest to the centre of reciprocation, and the spring magnet element 4E is the outer element in the sense that it is furthest from the centre of reciprocation. As the piston first begins to progress beyond its normal operating stroke, the inner magnet element 4D produces a restoring force on the drum as depicted by the peak 25 in FIG. 7B. If this is insufficient to reverse the direction of the drum and the drum moves further from the central position, the outer spring element 4E produces a second restoring force on the drum 2 depicted by peak 26 in FIG. 7B. This effectively provides a back-up force to the force provided by the inner spring elements 4D.

A sixth example of the invention is shown in FIG. 8. Again, this has many of the features of the earlier examples. The outer stator 7 has a radially inwardly extending flange 30 which projects across the gap between the inner and outer stator elements. It will be appreciated that the flange 30 could equally extend radially outwardly from the inner stator element 6. The spring magnet 4F is fixed to the downwardly facing surface of the flange 30 and is directly in the path of the reciprocating drum 2. A rubber cushion 31 is positioned on the lower surface of the spring magnet 4F which provides cushioning for any impact from the drum 2. As can be seen in FIG. 8, the spring magnet 4F is magnetised at the same polarity as the auxiliary magnet 20 on the drum. If no auxiliary magnets are present, then the spring magnet 4F would be magnetised at the same polarity as the power magnet 3. As the drum 2 approaches the spring magnet 4F, the magnets of the same polarity generate a repelling force which increases as the distance between the magnets reduces. In extreme cases, the force generated by the magnets will not be sufficient to stop the drum, at which point the drum 2 collides with the cushion 31 bringing it to an abrupt halt. The axially spaced spring magnet 4F may be provided in addition to radially spaced spring magnets 4G which operate in a similar manner to those described in the previous examples, or may operate alone without these magnets. As mentioned above, this example may be implemented with or without the auxiliary magnets 20.

It would also be possible to have a similar arrangement at the lower end of the stator to provide a repelling force on the bottom of the auxiliary magnet 20 or power magnet 3.

1. A Stirling machine comprising a reciprocating power piston with a power magnet; a stator having a coil electromagnetically coupled to the power magnet; and at least one spring magnet arranged to provide an axial centring force on the piston, the spring magnet being fixed with respect to the stator.

2. A machine according to claim 1, wherein there is a spring magnet at each axial end of the stator.

3. A machine according to claim 1, wherein the power piston includes a hollow drum on which the power magnet is mounted, and the stator comprises an annular gap in which the drum and power magnet reciprocate.

4. A machine according to claim 3, wherein the spring magnet is positioned on a inner stator element.

5. A machine according to claim 3, wherein the spring magnet is positioned on an outer stator element.

6. A machine according to claim 2, wherein the axial spacing between the spring magnets is greater than the overall axial length of the power magnet.

7. A machine according to claim 6, wherein the axial spacing between the spring magnets is at least 10% greater than the overall axial length of the power magnet.

8. A machine according to claim 6, wherein the spacing between the spring magnets is at least 20% greater than the length of the power magnet.

9. A machine according to claim 1, wherein at least one of the spring magnets is comprised of two or more spring magnet sections spaced apart in the direction of reciprocation.

10. A machine according to claim 1, wherein at least one of the spring magnets is radially spaced from the reciprocating power piston.

11. A machine according to claim 1, wherein at least one of the spring magnets is axially spaced from the power piston such that the power piston reciprocates towards and away from the spring magnet in use.

12. A machine according to claim 11, wherein the axially spaced spring magnet is provided with a resilient cushion between the spring magnet and the power piston.

13. A machine according to claim 1, wherein at least one of the spring magnets is associated with a respective auxiliary magnet positioned on the power piston and is arranged to co-operate with its associated spring magnet to generate a centring force on the piston.
